(19) United States
(12) Patent Application Publication
(10) Pub. No.: US 2022/0061214 A1
(43) Pub. Date: Mar. 3, 2022

(54) Lawnmower Blade Assembly

(71) Applicant: Rodney Jarrett, Chicago, IL (US)

(72) Inventor: Rodney Jarrett, Chicago, IL (US)

(21) Appl. No.: 17/003,322

(22) Filed: Aug. 26, 2020

(51) Int. Cl. A01D 34/73; A01D 34/685

(52) U.S. Cl. CPC A01D 34/73; A01D 2101/00; A01D 34/685

(57) ABSTRACT

A lawnmower blade assembly includes a plurality of blades that each intersects each other at a central point having the plurality of blades radiating outwardly from the central point. The central point is mountable to an output shaft of a lawnmower thereby facilitating the plurality of blades to be rotated by the output shaft. Each of the plurality of blades has a cutting edge that faces the rotational direction of the output shaft to cut grass when the output shaft rotates. The plurality of blades is evenly spaced apart from each other around the central point thereby facilitating the plurality of blades to produce centripetal force that is balanced with respect to the central point wherein the plurality of blades is configured to enhance smoothness of the rotation of the output shaft.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to blade devices and more particularly pertains to a new blade device for enhancing efficiency of a lawnmower.

### (2) Description of Related Art Including Information Disclosed Under 37 CFR 1.97 and 1.98

The prior art relates to blade devices. The prior art discloses an elastomeric lawn mower blade. The prior art discloses a variety of different lawn mower blades, each having a centrally positioned hub that engages an output shaft of a lawnmower. Additionally, the prior art discloses a variety of different lawn mower blades each comprising a set of blades that are attachable together.

### BRIEF SUMMARY OF THE INVENTION

An embodiment of the disclosure meets the needs presented above by generally comprising a plurality of blades that each intersects each other at a central point having the plurality of blades radiating outwardly from the central point. The central point is mountable to an output shaft of a lawnmower thereby facilitating the plurality of blades to be rotated by the output shaft. Each of the plurality of blades has a cutting edge that faces the rotational direction of the output shaft to cut grass when the output shaft rotates. The plurality of blades is evenly spaced apart from each other around the central point thereby facilitating the plurality of blades to produce centripetal force that is balanced with respect to the central point wherein the plurality of blades is configured to enhance smoothness of the rotation of the output shaft.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a lawnmower blade assembly according to an embodiment of the disclosure.

FIG. 2 is a top view of an embodiment of the disclosure.

FIG. 3 is a front view of an embodiment of the disclosure.

FIG. 4 is a perspective in-use view of an embodiment of the disclosure.

### DETAILED DESCRIPTION OF THE INVENTION

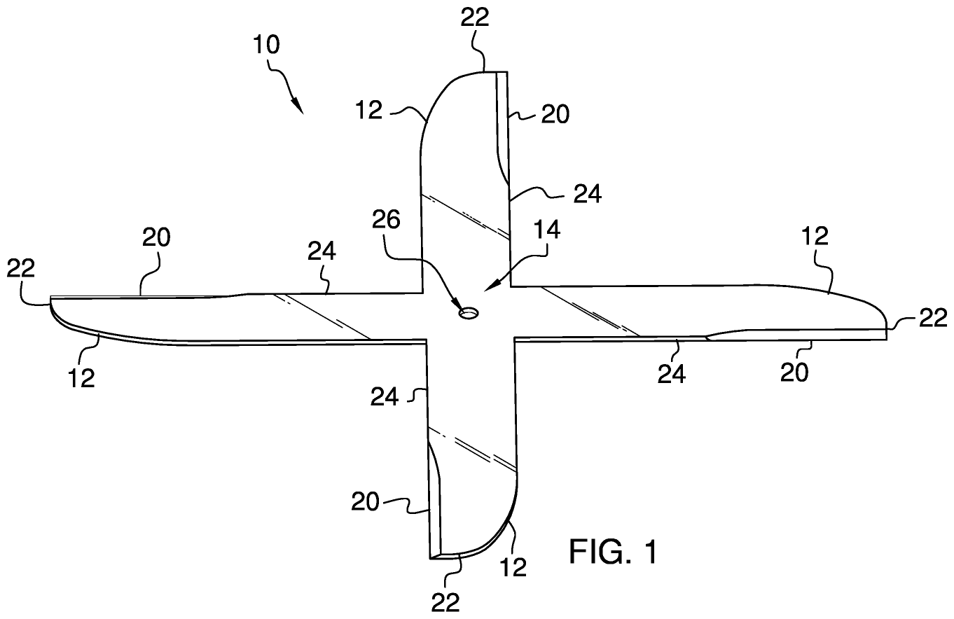

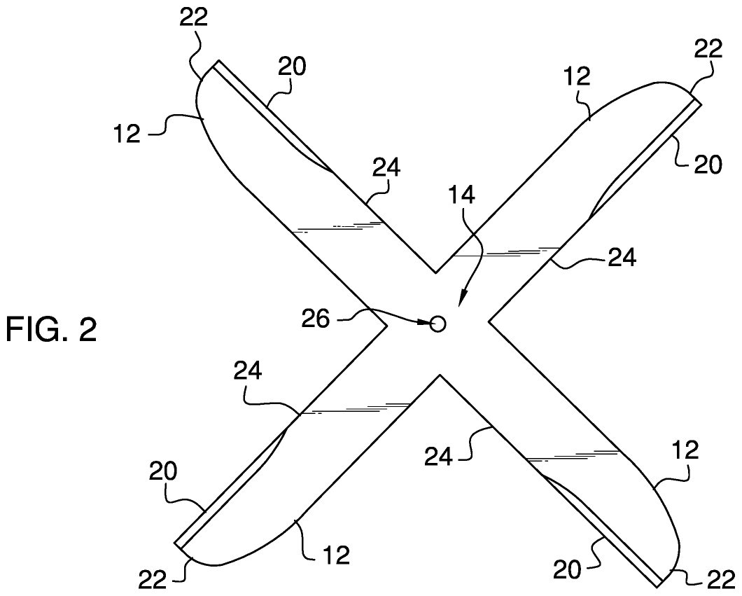

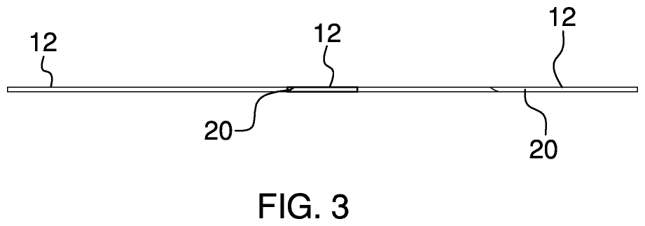

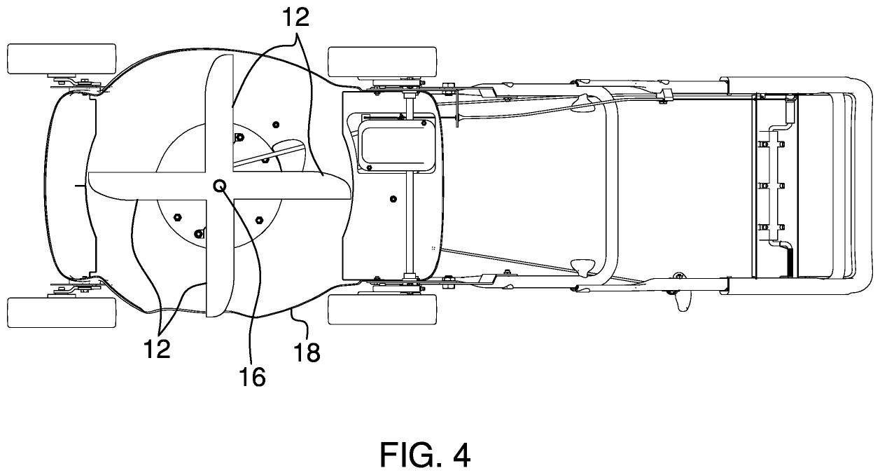

With reference now to the drawings, and in particular to FIGS. 1 through 4 thereof, a new blade device embodying the principles and concepts of an embodiment of the disclosure and generally designated by the reference numeral 10 will be described.

As best illustrated in FIGS. 1 through 4, the lawnmower blade assembly 10 generally comprises a plurality of blades 12 that each intersects each other at a central point 14. Moreover, the plurality of blades 12 radiate outwardly from the central point 14. The central point 14 is mountable to an output shaft 16 of a lawnmower 18 thereby facilitating the plurality of blades 12 to be rotated by the output shaft 16. Each of the plurality of blades 12 has a cutting edge 20 that faces the rotational direction of the output shaft 16. In this way the blades 12 can cut grass when the output shaft 16 rotates. The lawnmower 18 may have an internal combustion motor, an electric motor or any other conventional means of rotating the output shaft 16. Additionally, the plurality of blades 12 is each comprised of a rigid material, such as iron, steel or other traditional material with respect to lawnmower blades.

The blades 12 are evenly spaced apart from each other around the central point 14 thereby facilitating the plurality of blades 12 to produce centripetal force that is balanced with respect to the central point 14. In this way the plurality of blades 12 enhance smoothness of the rotation of the output shaft 16. Moreover, the plurality of blades 12 develops greater inertia than a single blade thereby enhancing the efficiency of the output shaft 16 with respect to fuel consumption of the lawnmower's motor.

Each of the blades 12 has a distal end 22 with respect to the central point 14 and each of the blades 12 has a front edge 24 that faces the rotational direction of the output shaft 16. A shaft hole 26 extends through the central point 14 and the shaft hole 26 insertably receives the output shaft 16. In this way each of the blades 12 extends along a line that is oriented perpendicular to a rotational axis of the output shaft 16 when the plurality of blades 12 is positioned on the output shaft 16. The cutting edge 20 is positioned on the front edge 24 of a respective one of the blades 12 and the cutting edge 20 extends from the distal end 22 of the respective blade toward the central point 14. Additionally, the plurality of blades 12 is oriented at a right angle with respect to each other.

In use, the plurality of blades 12 is positioned on the output shaft 16 of the lawnmower 18 such that the front edge 24 of the blades 12 faces the rotational direction of the output shaft 16. In this way the cutting edge 20 on each of the blades 12 can cut grass when the lawnmower 18 is being employed. The plurality of blades 12, in conjunction with the perpendicular orientation of the blades 12 with respect to each other, increases the centripetal inertia that is created when the output shaft 16 rotates. In this way the plurality of blades 12 enhances efficiency with which the grass is cut and reduces vibrations in the lawnmower 18 compared to a traditional, single blade.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lawnmower blade assembly having four blades each being oriented at right angles with each other for enhancing efficiency of a lawnmower, said assembly comprising:
a plurality of blades, each of said blades intersecting each other at a central point having said plurality of blades radiating outwardly from said central point, said central point being mountable to an output shaft of a lawnmower wherein said plurality of blades is configured to be rotated by the output shaft, each of said plurality of blades having a cutting edge that faces the rotational direction of the output shaft wherein each of said blades is configured to cut grass when the output shaft rotates, said plurality of blades being evenly spaced apart from each other around said central point thereby facilitating said plurality of blades to produce centripetal force that is balanced with respect to said central point wherein said plurality of blades is configured to enhance smoothness of the rotation of the output shaft.

2. The assembly according to claim 1, wherein each of said blades has a distal end with respect to said central point, each of said blades having a front edge that faces the rotational direction of the output shaft.

3. The assembly according to claim 2, wherein said cutting edge being positioned on said front edge of a respective one of said blades, said cutting edge extending from said distal end of said respective blade toward said central point.

4. The assembly according to claim 1, wherein said plurality of blades is oriented at a right angle with respect to each other.

5. A lawnmower blade assembly having four blades each being oriented at right angles with each other for enhancing efficiency of a lawnmower, said assembly comprising:
a plurality of blades, each of said blades intersecting each other at a central point having said plurality of blades radiating outwardly from said central point, said central point being mountable to an output shaft of a lawnmower wherein said plurality of blades is configured to be rotated by the output shaft, each of said plurality of blades having a cutting edge that faces the rotational direction of the output shaft wherein each of said blades is configured to cut grass when the output shaft rotates, said plurality of blades being evenly spaced apart from each other around said central point thereby facilitating said plurality of blades to produce centripetal force that is balanced with respect to said central point wherein said plurality of blades is configured to enhance smoothness of the rotation of the output shaft, each of said blades having a distal end with respect to said central point, each of said blades having a front edge that faces the rotational direction of the output shaft, said cutting edge being positioned on said front edge of a respective one of said blades, said cutting edge extending from said distal end of said respective blade toward said central point, said plurality of blades being oriented at a right angle with respect to each other.

6. A lawnmower blade system having four blades each being oriented at right angles with each other for enhancing efficiency of a lawnmower, said system comprising:
a lawnmower having an output shaft; and
a plurality of blades, each of said blades intersecting each other at a central point having said plurality of blades radiating outwardly from said central point, said central point being mountable to said output shaft of said lawnmower such that said plurality of blades is rotated by said output shaft, each of said plurality of blades having a cutting edge that faces the rotational direction of said output shaft wherein each of said blades is configured to cut grass when said output shaft rotates, said plurality of blades being evenly spaced apart from each other around said central point thereby facilitating said plurality of blades to produce centripetal force that is balanced with respect to said central point for enhancing smoothness of the rotation of said output shaft, each of said blades having a distal end with respect to said central point, each of said blades having a front edge that faces the rotational direction of the output shaft, said cutting edge being positioned on said front edge of a respective one of said blades, said cutting edge extending from said distal end of said respective blade toward said central point, said plurality of blades being oriented at a right angle with respect to each other.
